(19) United States
(12) Patent Application Publication
(10) Pub. No.: US 2025/0348507 A1
(43) Pub. Date: Nov. 13, 2025

(54) PREREQUISITE RELATIONSHIP EXTRACTION DEVICE, PREREQUISITE RELATIONSHIP EXTRACTION METHOD, AND PREREQUISITE RELATIONSHIP EXTRACTION PROGRAM

(71) Applicant: Nippon Telegraph and Telephone Corporation, Tokyo (JP)

(72) Inventors: Takaaki MORIYA, Musashino-shi, Tokyo (JP); Ai TSUNODA, Musashino-shi, Tokyo (JP); Manabu NISHIO, Musashino-shi, Tokyo (JP); Taizo YAMAMOTO, Musashino-shi, Tokyo (JP); Yu MIYOSHI, Musashino-shi, Tokyo (JP)

(21) Appl. No.: 18/869,012

(22) PCT Filed: Jun. 8, 2022
(86) PCT No.: PCT/JP2022/023155

§ 371 Date: Nov. 25, 2024

(51) Int. Cl. G06F 16/25

(52) U.S. Cl. CPC G06F 16/254

(57) ABSTRACT

The present invention includes: a preceding degree calculation unit (1) that calculates a degree of preceding of time series data xj of an item j with respect to time series data xi of an item i from a plurality of pieces of data; a similarity calculation unit (2) that calculates a semantic similarity between the time series data xi and the time series data xj; a surprise degree calculation unit (3) that calculates a degree of surprise indicating surprise of combining the item i and the item j on the basis of the degree of preceding and the semantic similarity; a causality testing unit (4) that tests causality of the item i and the item j; and a presentation unit (5) that presents the degree of surprise and presence or absence of the causality.

### TECHNICAL FIELD

The present invention relates to a preceding relationship extraction device, a preceding relationship extraction method, and a preceding relationship extraction program.

### BACKGROUND ART

It is expected that a new value is generated by extracting a preceding relationship that is difficult to conceive by human sense from a large amount of data. For example, the preceding relationship that “gasoline prices tend to fluctuate prior to electricity rates” is easy to conceive by human sense, and the value of the data is low. On the other hand, the preceding relationship that “the price of the ring tends to fluctuate prior to the use amount of city gas (imaginary example)” is a relationship that is difficult to conceive by human sense (hereinafter, referred to as “unexpected preceding relationship”), and the value of the data is high.

Non Patent Literature 1 discloses, as a method for analyzing a preceding relationship between time-series variables, displaying a relationship between time-series variables with a time delay using a cross correlation function (CCF).

Patent Literature 1 discloses, in a regression model (VAR), calculating the strength of the causal relationship between time-series variables from the magnitude of the influence of the variation of the error term and the minute change amount. Patent Literature 2 discloses using cross-correlation for learning of word vectors.

### CITATION LIST

### Patent Literature

Patent Literature 1: JP 6730340 B2
Patent Literature 2: JP 6620950 B2

### Non Patent Literature

Non Patent Literature 1: Shigeru Aoki, “Taiki kaiyo kaisekiho tokuron, sokan/kaiki (in Japanese) (Atmospheric Ocean Analysis Method, Correlation/Regression)”, http://climbsd.lowtem.hokudai.ac.jp/group/shigeru/tc/dataan2012/num4.pdf, http://climbsd.lowtem.hokudai.ac.jp/group/shigeru/tc/dataan2012/index.htm

### SUMMARY OF INVENTION

### Technical Problem

However, in the method using the cross correlation function (CCF) disclosed in Non Patent Literature 1 and the method using the regression model (VAR) disclosed in Patent Literature 1, the preceding relationship that is easily conceived by human sense is extracted, and it is difficult to excerpt and extract an unexpected preceding relationship. The technology disclosed in Patent Literature 2 cannot extract an unexpected preceding relationship. In addition, in each of the literatures described above, a preceding relationship useful for the future prediction, that is, a preceding relationship that “the item A is useful for the future prediction of the item B” cannot be extracted.

The present invention has been made in view of the above circumstances, and an object of the present invention is to provide a preceding relationship extraction device, a preceding relationship extraction method, and a preceding relationship extraction program capable of extracting a preceding relationship that is difficult to conceive by human sense and is useful for future prediction from a plurality of pieces of data.

### Solution to Problem

A preceding relationship extraction device according to an aspect of the present invention includes: a preceding degree calculation unit that calculates a degree of preceding of time series data xj of an item j with respect to time series data xi of an item i from a plurality of pieces of data; a similarity calculation unit that calculates a semantic similarity between the time series data xi and the time series data xj; a surprise degree calculation unit that calculates a degree of surprise indicating surprise of combining the item i and the item j on the basis of the degree of preceding and the semantic similarity; a causality testing unit that tests causality of the item i and the item j; and a presentation unit that presents the degree of surprise and presence or absence of the causality.

A preceding relationship extraction device according to another aspect of the present invention includes: a preceding degree calculation unit that tests causality between time series data xj of an item j and time series data xi of an item i from a plurality of pieces of data and calculates a degree of preceding of the item j with respect to the item i by a test result; a similarity calculation unit that calculates a semantic similarity between the time series data xi and the time series data xj; a surprise degree calculation unit that calculates a degree of surprise indicating surprise of combining the item i and the item j on the basis of the degree of preceding and the semantic similarity; and a presentation unit that presents the degree of surprise.

A preceding relationship extraction method according to an aspect of the present invention includes steps of: calculating a degree of preceding of time series data xj of an item j with respect to time series data xi of an item i from a plurality of pieces of data; calculating a semantic similarity between the time series data xi and the time series data xj; calculating a degree of surprise indicating surprise of combining the item i and the item j on the basis of the degree of preceding and the semantic similarity; testing causality of the item i and the item j; and presenting the degree of surprise and presence or absence of the causality.

An aspect of the present invention is a preceding relationship extraction program for causing a computer to function as the preceding relationship extraction device.

### Advantageous Effects of Invention

According to the present invention, it is possible to extract a preceding relationship that is difficult to conceive by human sense and is useful for future prediction from a plurality of pieces of data.

### BRIEF DESCRIPTION OF DRAWINGS

FIG. 1 is a block diagram illustrating a configuration of a preceding relationship extraction device according to a first embodiment.

FIG. 2A is a graph of time series data xi, t and time series data xj, t.

FIG. 2B is an explanatory diagram illustrating an example of comparing numerical values at a time immediately before xj, t with reference to xi, t.

FIG. 2C is a graph plotting xi, t at time t on the horizontal axis and xj, t−1 at time t−1 on the vertical axis.

FIG. 2D is an explanatory diagram illustrating an example of comparing numerical values at a time two times before xj, t with reference to xi, t.

FIG. 2E is a graph plotting xi, t at time t on the horizontal axis and xj, t−2 at time t−2 on the vertical axis.

FIG. 2F is a graph in which a horizontal axis represents a delay time k and a vertical axis represents a cross correlation function Rij(k).

FIG. 3 is an explanatory diagram illustrating a maximum value and an average value in a graph in which a horizontal axis is a delay time k and a vertical axis is a cross correlation function Rij(k).

FIG. 4 is an explanatory diagram illustrating an example of setting a degree of surprise rij on a plane of a graph with a semantic similarity uij on a horizontal axis and a correlation strength vij on a vertical axis.

FIG. 5 is an explanatory diagram illustrating an example of setting a degree of surprise rij with any point as a start point, on a plane of a graph with a semantic similarity uij on a horizontal axis and a correlation strength vij on a vertical axis.

FIG. 6 is an explanatory diagram illustrating an example of setting a degree of surprise rij on a plane of a graph with a standardized semantic similarity uij on a horizontal axis and a standardized degree of preceding vij on a vertical axis.

FIG. 7 is an explanatory diagram illustrating an example of calculating a degree of surprise rij by a Euclidean distance or a Mahalanobis distance.

FIG. 8 is an explanatory diagram illustrating a residual between a regression equation and observation data.

FIG. 9 is a graph showing an F distribution obtained by a Granger causality test, in which (a) shows a case where the F value matches Fα, and (b) shows a case where the F value is larger than Fα.

FIG. 10 is a flowchart illustrating a processing procedure by the preceding relationship extraction device according to the first embodiment.

FIG. 11 is an explanatory diagram illustrating an example of degree of surprise ranking presented in a presentation unit according to the first embodiment.

FIG. 12 is a diagram for describing Expression (12).

FIG. 13 is a diagram for describing Expression (13).

FIG. 14 is a block diagram illustrating a configuration of a preceding relationship extraction device according to a second embodiment.

FIG. 15 is a flowchart illustrating a processing procedure by the preceding relationship extraction device according to the second embodiment.

FIG. 16 is an explanatory diagram illustrating an example of degree of surprise ranking presented in a presentation unit according to the second embodiment.

FIG. 17 is a block diagram illustrating a hardware configuration of the present embodiment.

### DESCRIPTION OF EMBODIMENTS

### First Embodiment

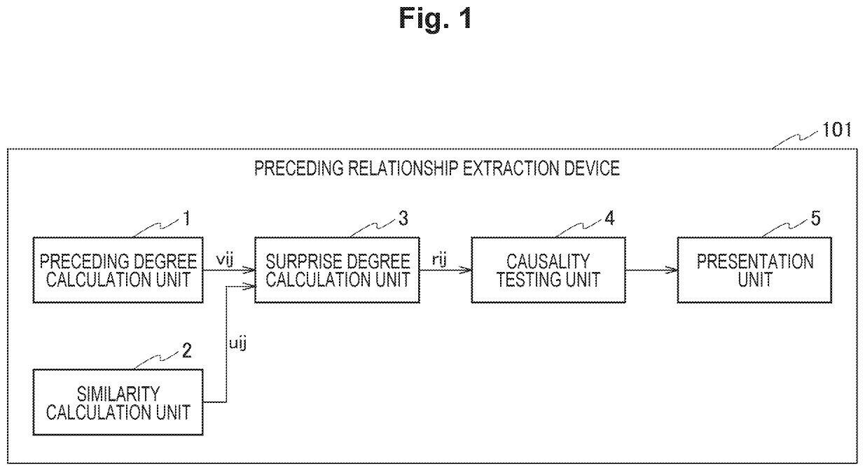

Hereinafter, a first embodiment will be described. FIG. 1 is a block diagram illustrating a configuration of a preceding relationship extraction device according to the first embodiment. As illustrated in FIG. 1, a preceding relationship extraction device 101 includes a preceding degree calculation unit 1, a similarity calculation unit 2, a surprise degree calculation unit 3, a causality testing unit 4, and a presentation unit 5.

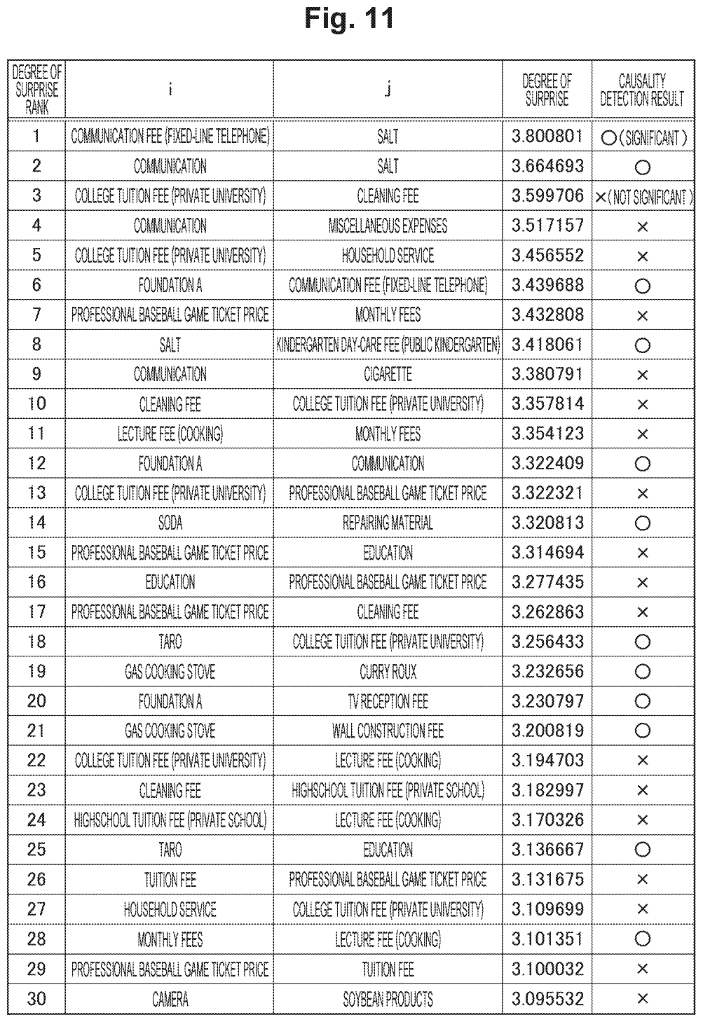

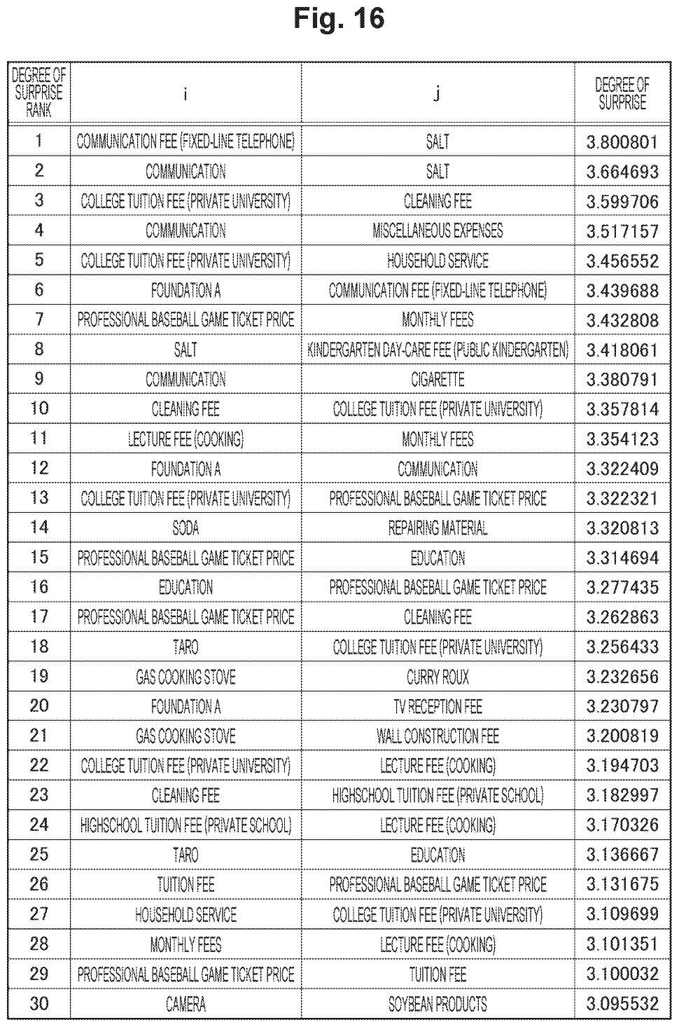

The preceding degree calculation unit 1 calculates a correlation strength vij, which is an example of the degree of preceding, on the basis of the cross correlation function of time series data xi and time series data xj. When time series data of an item i is xi (hereinafter, abbreviated as “data xi”) and time series data of an item j is xj (hereinafter, abbreviated as “data xj”), the preceding degree calculation unit 1 quantifies the degree of preceding of the data xi with respect to the data xj. Specifically, the preceding degree calculation unit 1 calculates a cross correlation function for two items i and j included in a plurality of pieces of data. The “item” means a generic term for an article, a food, a service, and the like as illustrated in columns “i” and “j” in FIGS. 11 and 16 described later. The “time series data” is data given in time series, and includes, for example, in a case where the item is gasoline, data indicating a gasoline price of oo yen in April, oo yen in May, and oo yen in June.

The preceding degree calculation unit 1 calculates a correlation strength vij from the cross correlation function. Details of the correlation strength vij will be described later. The correlation strength is an example of the degree of preceding. In the present embodiment, an example will be described in which a cross correlation function is employed as a method of calculating a degree of preceding; however, other methods may be employed.

On the basis of a semantic vector of the data xi and a semantic vector of the data xj, the similarity calculation unit 2 calculates semantic similarity indicating semantic closeness between the data xi and the data xj. The similarity calculation unit 2 uses “Word2vec (word to vector)” as a method of calculating the semantic vector. By using “Word2vec”, the semantic vector of the data xi and the semantic vector of the data xj are calculated. The similarity calculation unit 2 calculates the semantic similarity uij between the semantic vector of the data xi and the semantic vector of the data xj.

Here, an example of using cosine similarity as an example of the semantic similarity uij will be described. That is, the similarity calculation unit 2 calculates cosine similarity between the semantic vector of the item i and the semantic vector of the item j. Details of the semantic similarity uij will be described later. In the present embodiment, an example in which “Word2vec” is adopted for calculation of the semantic vector and an example in which the cosine similarity is adopted as a method of calculating the semantic similarity will be described, but other methods may be adopted.

The surprise degree calculation unit 3 calculates the degree of surprise rij on the basis of the correlation strength vij calculated by the preceding degree calculation unit 1 and the semantic similarity uij calculated by the similarity calculation unit 2. The degree of surprise rij is an index indicating surprise of combining the item i and the item j. Details of the degree of surprise rij will be described later. The surprise degree calculation unit 3 sets a component in an upper left 45° direction (135° direction) of an orthogonal coordinate system in which a horizontal axis is uij and a vertical axis is vij as a degree of surprise rij of a set of items “i, j”.

The causality testing unit 4 tests the causality between the item i and the item j. In the present embodiment, the presence or absence of the Granger causality in the item i and the item j is determined by performing the Granger causality test. As is well known, the Granger causality is an index indicating whether or not the numerical value of the time series data X can provide statistically significant information regarding the numerical value of future time series data Y by the t-test and the F-test for the two pieces of time series data X and Y. When it is proven that the numerical value of X can provide statistically significant information on the numerical value of Y in the future, it is determined that the Granger causality from the time series data X to the time series data Y is significant.

The presentation unit 5 displays an image of the degree of surprise rij calculated by the surprise degree calculation unit 3 and the result of the Granger causality test performed by the causality testing unit 4 on a display or the like in a ranking format to notify the user. That is, the presentation unit 5 presents a combination of two items (item i and item j) in a ranking format in descending order of the degree of surprise. The presentation unit 5 may notify the user of each piece of information not only by an image but also by voice, for example.

### [Method for Calculating Cross Correlation Function]

Next, a method of calculating the cross correlation function executed by the preceding degree calculation unit 1 will be described. The preceding degree calculation unit 1 calculates a cross correlation function “Rij(k)” for the data xi and xj by the following Expression (1). The cross correlation function “Rij(k)” is an index indicating how much the data xj precedes the data xi.

$$\begin{matrix}[ Math . 1 ] & \\ {R}_{ij} ( k ) = \frac{{\sum }_{t = 1 + k}^{n} ( {x}_{i , t} - \overline{{x}_{i}} ) ( {x}_{j , t - k} - \overline{{x}_{j}} )}{\sqrt{{\sum }_{t = 1}^{n} {( {x}_{i , t} - \overline{{x}_{i}} )}^{2}} \sqrt{{\sum }_{t = 1}^{n} {( {x}_{j , t} - \overline{{x}_{j}} )}^{2}}} & ( 1 )\end{matrix}$$

In Expression (1), “k” is a positive integer and indicates a delay time. Expression (1) is a correlation coefficient between “xi” and “xj shifted forward by the delay time k”. Expression (1) satisfies “−1≤Rij(k)≤1” due to the nature of the expression.

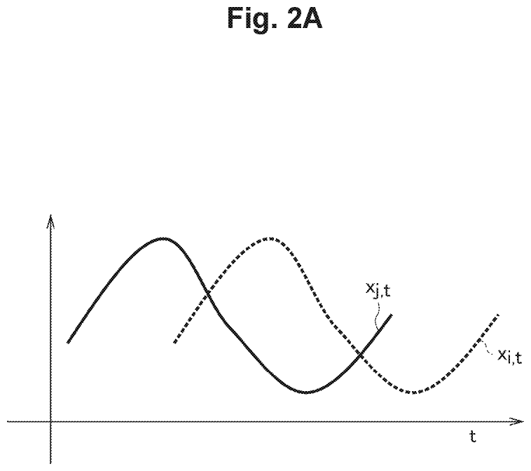

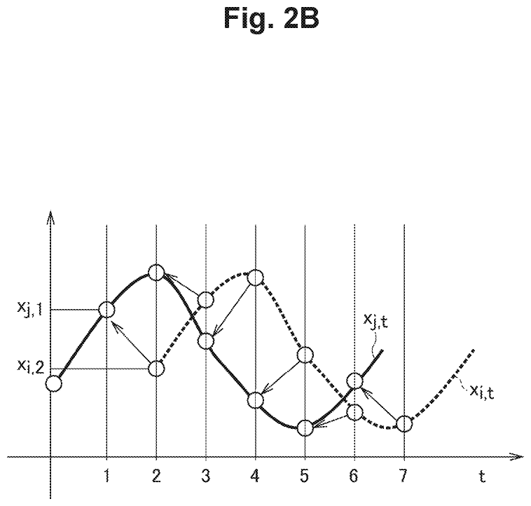

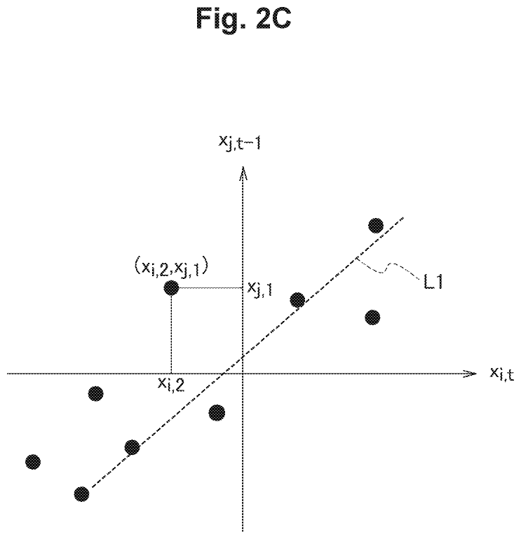

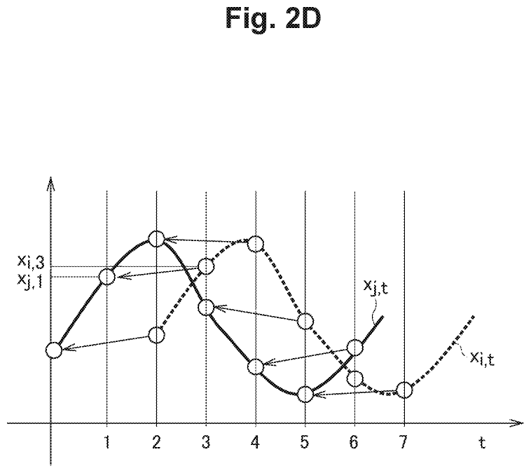

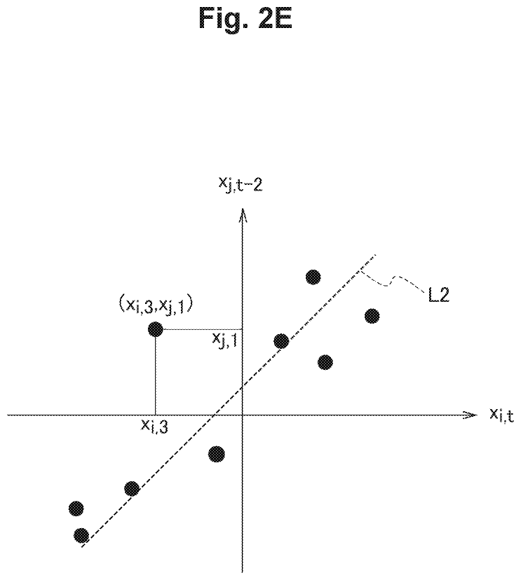

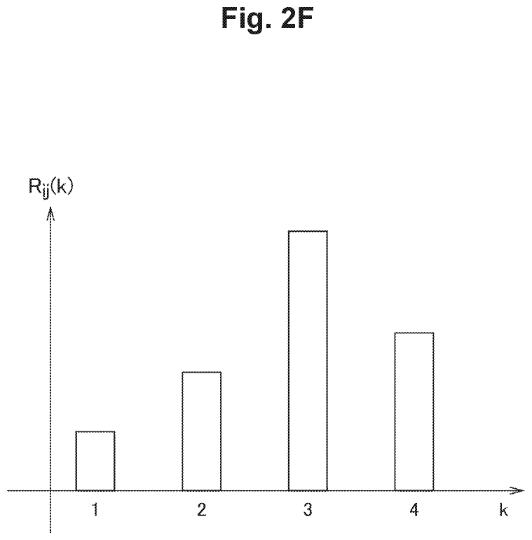

For example, it is assumed that two pieces of data xj, t, xi, t are given as illustrated in FIG. 2A. t represents the time at which the data is obtained.

A calculation procedure of the cross correlation function Rij(1) when “k=1” will be described with reference to FIGS. 2B and 2C. As illustrated in FIG. 2B, numerical values at a time immediately before xj are compared with reference to xi, and “xi, t” is plotted on the horizontal axis and “xj, t−1” is plotted on the vertical axis. As a result, for example, as illustrated in FIG. 2C, a scatter diagram in which a plurality of points are plotted is obtained. The inclination of a straight line L1 connecting the points illustrated in FIG. 2C indicates a cross correlation function Rij(1).

Next, a calculation procedure of a cross correlation function Rij(2) when “k=2” will be described with reference to FIGS. 2D and 2E. As illustrated in FIG. 2D, numerical values at a time two times before xj are compared with reference to xi, and “xi, t” is plotted on the horizontal axis and “xj, t−2” is plotted on the vertical axis. As a result, for example, as illustrated in FIG. 2E, a scatter diagram in which a plurality of points are plotted is obtained. The inclination of a straight line L2 connecting the points illustrated in FIG. 2E indicates a cross correlation function Rij(2).

A cross correlation function Rij(k) is calculated with the above calculation as k=1, 2, 3, . . . . As a result, for example, as illustrated in FIG. 2F, the cross correlation function Rij(k) having a delay time k as a variable is obtained.

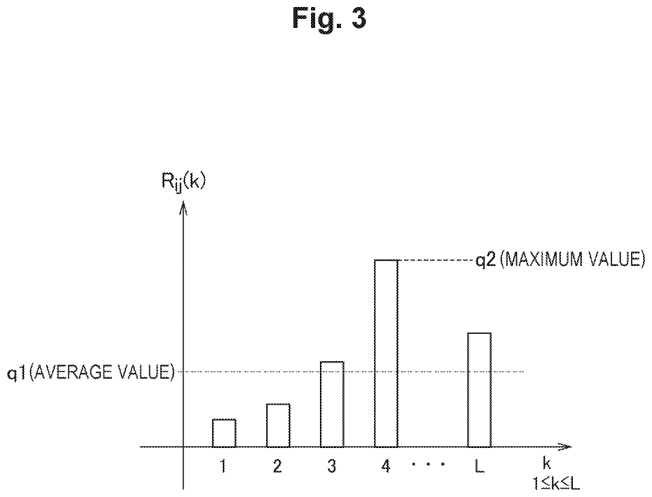

The cross correlation function Rij(k) calculated by the above method is a function of the delay time k. The preceding degree calculation unit 1 calculates a representative value (scalar) of the cross correlation function Rij(k) by any of the following methods (a) to (d) in order to facilitate synthesis with the semantic similarity uij to be described later. This representative value is defined as a correlation strength vij. The correlation strength vij may be a value representing Rij(k), and methods other than (a) to (d) may be used.
(a) An average value in 1≤k≤L of Rij(k) calculated by the following Expression (2) is defined as a correlation intensity vij. Reference sign q1 in FIG. 3 represents an average value.

$$\begin{matrix}[ Math . 2 ] & \\ {v}_{i j} = \frac{1}{2 L + 1} {{\sum }^{+ L}}_{k = - L} {R}_{i j} ( k ) & ( 2 )\end{matrix}$$

(b) The maximum value in 1≤k≤L of Rij(k) calculated by the following Expression (3) is set as the correlation intensity vij. Reference sign q2 in FIG. 3 represents the maximum value.

$$\begin{matrix}[ Math . 3 ] & \\ {v}_{i j} = max ( {R}_{i j} ( k ) ) & ( 3 )\end{matrix}$$

(c) A standard deviation σij at 1≤k≤L of Rij(k) calculated by the following Expression (4) is defined as a correlation intensity vij. (4) In the expression, u represents an average value, and E{⋅} represents an average of “⋅”.

$$\begin{matrix}[ Math . 4 ] & \\ {v}_{ij} = {σ}_{i j} = \sqrt{E \{ {( {R}_{i j} ( k ) - μ )}^{2} \}} & ( 4 )\end{matrix}$$

(d) A kurtosis αij at 1≤k≤L of Rij(k) calculated by the following expression (5) is defined as a correlation intensity vij.

$$\begin{matrix}[ Math . 5 ] & \\ {v}_{i j} = {α}_{ij} = {E ( {R}_{i j} ( k ) - μ )}^{4} / {σ}_{ij}^{4} & ( 5 )\end{matrix}$$

In the present embodiment, an example in which the maximum value illustrated in (b) above is set as the correlation strength vij will be described. For example, when the cross correlation function Rij(k) illustrated in FIG. 3 is obtained, the cross correlation function of “k=4” is set as the correlation strength vij.

[Method for Calculating Semantic Similarity uij]

The similarity calculation unit 2 acquires the distributed representation of the item i, that is, a semantic vector wi, and the distributed representation of the item j, that is, a semantic vector wj, using “Word2vec” described above or the like. For example, wi=(0.5, 0.2, 0.4, . . . , 0.1) and wj=(0.2, 0.1, 0.8, . . . , 0.7) are obtained.

The similarity calculation unit 2 calculates cosine similarity between the distributed representations wi and wj by the following Expression (6), and sets the cosine similarity as semantic similarity uij. The semantic similarity uij is an index indicating ease of thinking by a human that i and j have some relationship. When cosine similarity is used, −1≤uij≤1 is satisfied by definition.

$$\begin{matrix}[ Math . 6 ] & \\ {u}_{i j} = \frac{{w}_{i} \cdot {w}_{j}}{\vert {w}_{i} \vert \vert {w}_{j} \vert} & ( 6 )\end{matrix}$$

[Method for Calculating Degree of Surprise rij]

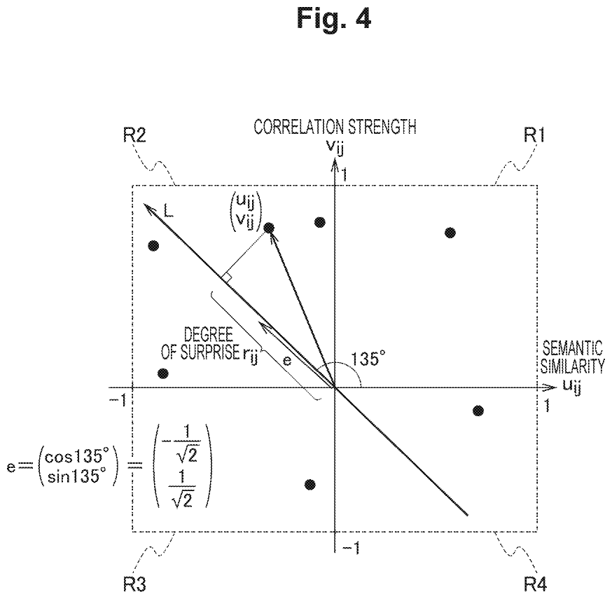

As illustrated in FIG. 4, the surprise degree calculation unit 3 sets a graph (u-v plane) in which the horizontal axis represents the semantic similarity uij calculated by the similarity calculation unit 2 and the vertical axis represents the correlation strength vij calculated by the preceding degree calculation unit 1. In the u-v plane illustrated in FIG. 4, the more rightward the direction is, the greater the semantic similarity uij is, and the more upward the direction is, the greater the correlation strength vij is.

In the u-v plane illustrated in FIG. 4, the upper right first quadrant R1 is a region that can be easily analogized by a human, that is, “i and j have similar meanings and have a preceding relationship”, and the lower left third quadrant R3 is a region that can be easily analogized, that is, “i and j have no similar meaning and have no preceding relationship”. In addition, the second quadrant R2 on the upper left is a region having a strong correlation although the meanings are not similar, and is a region having surprise for humans.

The surprise degree calculation unit 3 sets a straight line L in a direction of 135° in the u-v plane illustrated in FIG. 4, and sets a component in the direction of the straight line L of a vector (uij, vij) of a set of items “i, j” as a degree of surprise rij. Specifically, a unit vector in the (−1, 1) direction on the u-v plane in FIG. 4, that is, (cos 135°, sin) 135°=(−1/√2, 1/√2) is set as a unit vector e, and an inner product of the unit vector e and the vector (uij, vij) is set as a degree of surprise rij.

The degree of surprise rij can be set to the following (first modification) to (third modification) in addition to the above.

### Modification 1

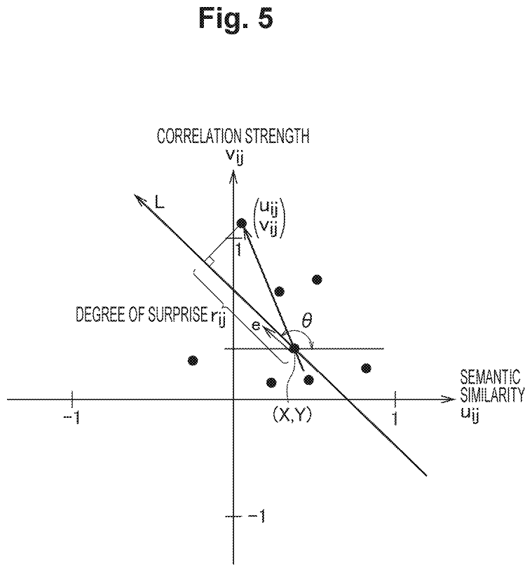

In the above example, the unit vector e is a 135° vector starting from the origin (0, 0). In a first modification, a vector having an angle θ with preset coordinates (X, Y) as a start point is set as a unit vector e in a more generalized manner as illustrated in FIG. 5. Furthermore, in consideration of the distribution bias, the (X, Y) may be set as the coordinates (uu, uv) using an average value uu of uij and an average value uv of vij. Furthermore, the angle θ may be set to 135° or may be appropriately set by the user.

### Modification 2

Since the semantic similarity uij and the correlation strength vij have different variations, numerical values obtained by normalizing uij and vij to an average of 0 and a variance of 1, respectively, are u′ij and v′ij, respectively. That is, u′ij and v′ij are calculated by the following Expression (7).

$$\begin{matrix}[ Math . 7 ] & \\ {u}_{i j}^{′} = \frac{{u}_{ij} - {μ}_{u}}{{σ}_{u}} , {v}_{i j}^{′} = \frac{{v}_{i j} - {μ}_{v}}{{σ}_{v}} & ( 7 )\end{matrix}$$

In Expression (7), uu and σu represent the average value and the standard deviation of the semantic similarity, and uv and σv represent the average value and the standard deviation of the correlation strength.

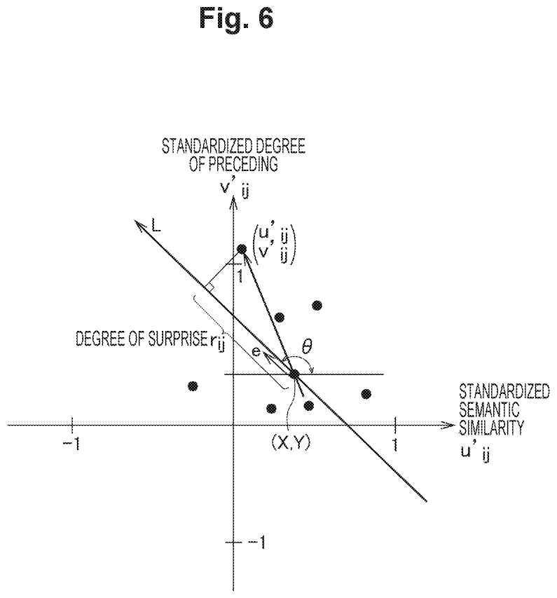

In a second modification, as illustrated in FIG. 6, with the semantic similarity set to u′ij instead of uij and v′ij instead of the correlation strength vij, the degree of surprise rij is calculated by the following Expression (8).

$$\begin{matrix}[ Math . 8 ] & \\ {r}_{i j} = {( \begin{matrix}{u}_{i j}^{′} \\ {v}_{ij}^{′}\end{matrix} )}^{T} e & ( 8 )\end{matrix}$$

### Modification 3

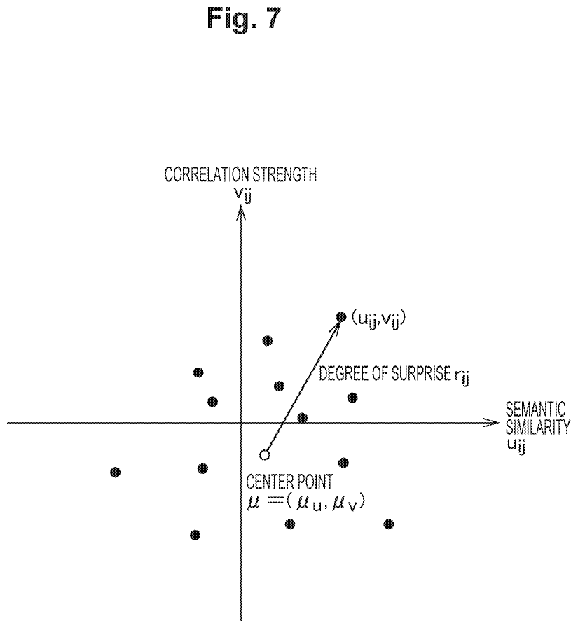

In the u-v plane, a set of items that deviates from the center point of the population is abnormal, and the set of items is likely to have surprise for humans. In the third modification, the degree of surprise rij of the set of items ij is set to a Euclidean distance from the center u of the population=(μu, μv) or a Mahalanobis distance. FIG. 7 is an explanatory diagram illustrating an example of calculating a degree of surprise rij by a Euclidean distance or a Mahalanobis distance.

When the center point u is μ=(μu, μv), μu and μv can be expressed by the following Expression (9).

$$\begin{matrix}[ Math . 9 ] & \\ \begin{matrix}{μ}_{u} = \frac{1}{{N}^{2}} {{\sum }_{i = 1}}^{N} {{\sum }_{j = 1}}^{N} {u}_{i j} \\ {μ}_{v} = \frac{1}{{N}^{2}} {{\sum }_{i = 1}}^{N} {{\sum }_{j = 1}}^{N} {v}_{i j}\end{matrix} & ( 9 )\end{matrix}$$

In Expression (9), “N” represents the number of samples.

When the Euclidean distance is used, the degree of surprise rij can be calculated by the following Expression (10). As a result, for example, as illustrated in FIG. 7, the degree of surprise rij is obtained.

$$\begin{matrix}[ Math . 10 ] & \\ {r}_{i j} = \sqrt{{( {u}_{i j} - {μ}_{u} )}^{2} + {( {v}_{i j} - {μ}_{v} )}^{2}} & ( 10 )\end{matrix}$$

In a case where the Mahalanobis distance is used, the degree of surprise rij can be calculated by Expression (11b) below on the basis of Expression (11a) below.

$$\begin{matrix}[ Math . 11 ] & \\ \begin{matrix}{x}_{i j} = ( \begin{matrix}{u}_{ij} \\ {v}_{ij}\end{matrix} ) , μ = ( \begin{matrix}{μ}_{u} \\ {μ}_{v}\end{matrix} ) , Σ = ( \begin{matrix}{σ}_{u}^{2} & {σ}_{u ν}^{2} \\ {σ}_{vu}^{2} & {σ}_{v}^{2}\end{matrix} ) \\ {σ}_{u}^{2} = \frac{1}{{N}^{2}} {\sum }_{i = 1}^{N} {\sum }_{j = 1}^{N} {( {u}_{ij} - {μ}_{u} )}^{2} \\ {σ}_{v}^{2} = \frac{1}{{N}^{2}} {\sum }_{i = 1}^{N} {\sum }_{j = 1}^{N} {( {v}_{ij} - {μ}_{u} )}^{2} \\ {σ}_{u v}^{2} = {σ}_{v u}^{2} = \frac{1}{{N}^{2}} {\sum }_{i = 1}^{N} {\sum }_{j = 1}^{N} \{ ( {u}_{ij} - {μ}_{u} ) ( {v}_{ij} - {μ}_{v} ) \}\end{matrix} & ( 11 a )\end{matrix}$$

$${r}_{ij} = \sqrt{{( {x}_{ij} - μ )}^{T} {Σ}^{- 1} ( {x}_{i j} - μ )} \qquad ( 11 b )$$

In a case where it is desired to extract a set of items having only a relationship of “j is a preceding indicator of i although meanings are different”, it is sufficient that a filter of a. only the upper left quadrant from the origin “uij<0 and vij>0” or b. the upper left quadrant from the center point (third quadrant when center point is limited) is applied. Since the correlation strength is calculated from the cross correlation function and the semantic similarity is calculated from the cosine similarity to be defined as “−1≤uij≤1, −1≤vij≤1”, pre-processing such as normalization and standardization is unnecessary, and the shape of the group is not distorted, and thus versatility is high.

### [Processing by Causality Testing Unit]

Next, processing of the causality testing unit 4 will be described. The causality testing unit 4 sets the VAR model for the data xi and xj, and performs the Granger causality test on the basis of the VAR model. Details will be described below.

### (Setting of VAR Model)

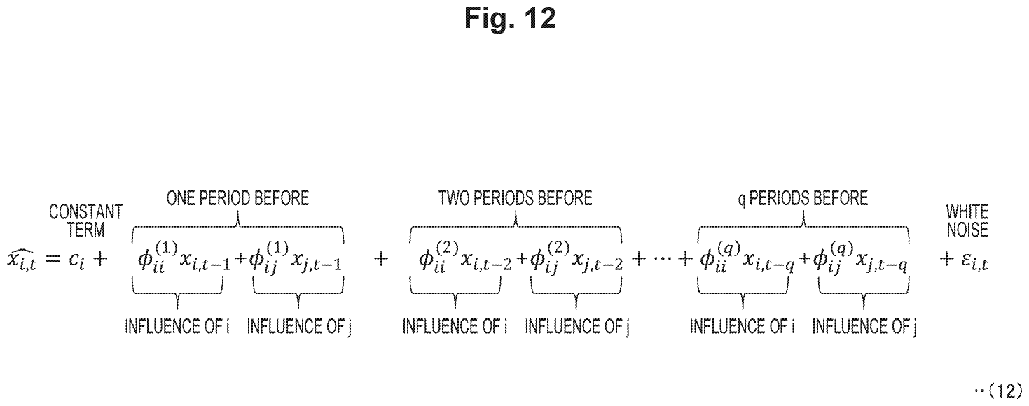

Data xi is modeled by Vector Auto Regressive (VAR) considering data xj. Specifically, the modeled time series data xi, t(\hat{ }) is set by Expression (12) illustrated in FIG. 12.

In the right side of Expression (12), the first term indicates a constant term, the second term indicates the influence of i one period before, the third term indicates the influence of j one period before, the fourth term indicates the influence of i two periods before, and so on. In Expression (12), “q” is a preset order, and is a numerical value indicating how many periods back. “φ” and “c” are coefficients, and are calculated by the least squares method on the basis of the observation data xi, t (t=1, 2, . . . , n). “εi, t” indicates white noise.

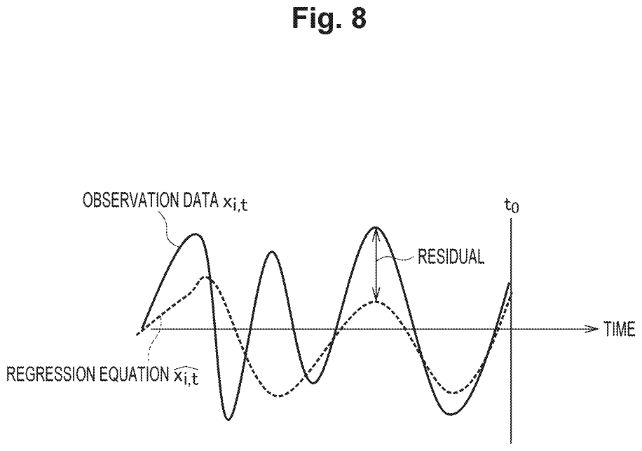

The causality testing unit 4 calculates a residual from the regression equation (however, ε is excluded) obtained by Equation (12) and the actual observation value. As illustrated in FIG. 8, the residual is a difference between the regression equation and the observation data. The causality testing unit 4 calculates the residual sum of squares (RSS).

### (Granger Causality Test)

The causality testing unit 4 performs a Granger causality test on the basis of the residual sum of squares calculated on the basis of the VAR model.

First, the coefficients φ and c shown in Expression (12) of FIG. 12 are calculated by the least squares method. The residual sum of squares according to the regression equation obtained as a result is defined as RSS₁.

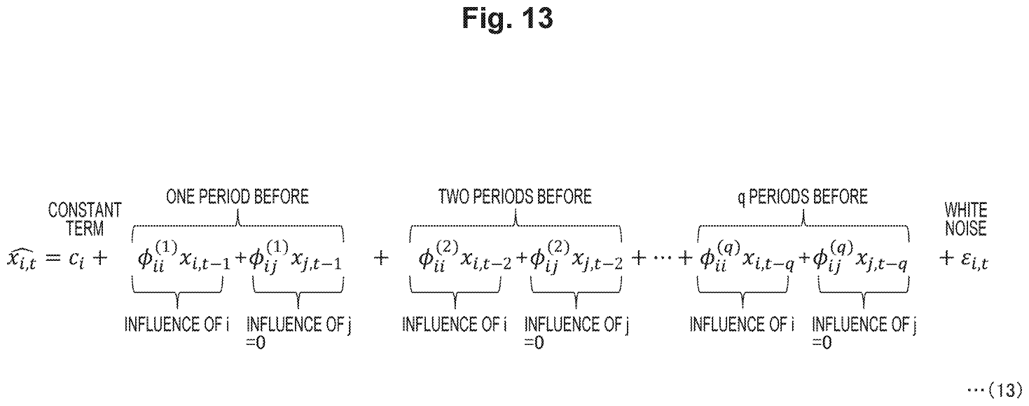

In the regression equation shown in Expression (12), φ and c when the influence of “j” is zero, that is, φij\hat{ }(1)=φij\hat{ }(2)= . . . =φij\hat{ }(q)=0 are calculated by the least squares method. As a result, Expression (12) becomes Expression (13) illustrated in FIG. 13. All terms affected by “j” such as the third term and the fifth term on the right side of Expression (13) are 0. The residual sum of squares according to the regression equation shown in Expression (13) is defined as RSS₀.

On the basis of the residual sum of squares RSS₁, RSS₀ described above, the statistic F is given by (14) below.

$$\begin{matrix}[ Math . 12 ] & \\ F = \frac{( R S {S}_{0} - R S {S}_{1} ) / q}{R S {S}_{1} / ( n - 2 q - 1 )} & ( 14 )\end{matrix}$$

In Expression (14), n represents the number of observation data points, and q represents the order of the VAR. When the statistic F shown in Expression (14) is larger than the 5% point of the F distribution of the degree of freedom (q, n−2q−1), the null hypothesis that “there is no Granger causality from xj to xi” is rejected.

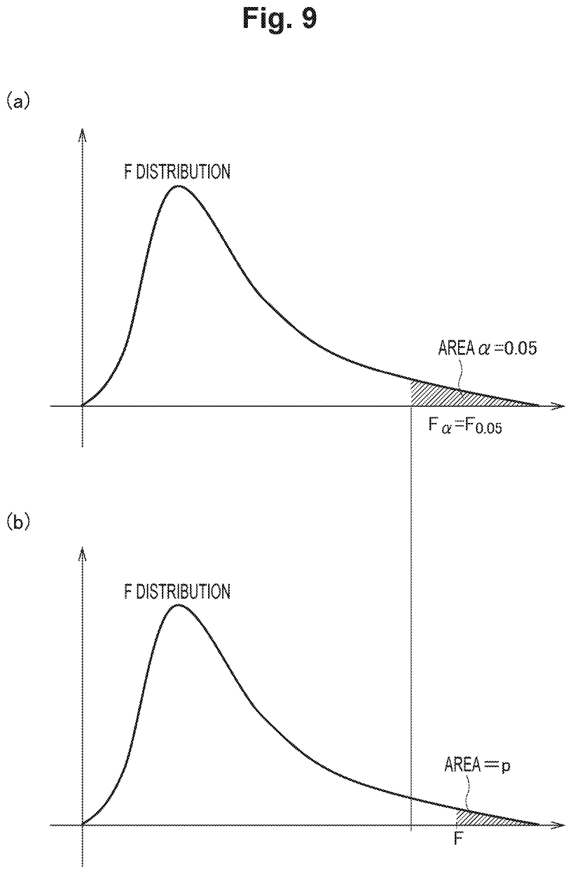

The case where Granger causality is not recognized (the causality is not significant) is the following cases (a1) to (a5).
(a1) The null hypothesis “φij(1)=φij(2)= . . . =0” is adopted.
(a2) Considering j does not improve the RSS of i.
(a3) The difference between RSS₀ and RSS₁ is small.
(a4) A statistic F illustrated in FIG. 9 (described later) is smaller than Fα.
(a5) The p value is greater than α.

On the other hand, the case where Granger causality is recognized (the causality is significant) is the following cases (b1) to (b5).
(b1) The null hypothesis “φij(1)=φij(2)= . . . =0” is adopted.
(b2) Considering j improves the RSS of i.
(b3) The difference between RSS₀ and RSS₁ is large.
(b4) F shown in FIG. 9 (described later) is larger than Fα.
(b5) The p value is smaller than α.

FIG. 9 is a graph (F distribution curve) showing the F distribution obtained by performing the F test on the data xi and xj. FIG. 9(a) illustrates a case where F=Fα(a is the level of significance, typically α=0.05), and FIG. 9(b) illustrates a case where F>Fα.

For example, a point at which the area of the upper tail is 0.05 (5%) of the whole is set to Fa. If the F value is smaller than Fα (in FIG. 9(a), the case of the region on the left side of Fα), the Granger causality is determined to be insignificant. On the contrary, when the F value is larger than Fα (in FIG. 9(a), the case of the region on the right side of Fα), it is estimated that a rare event has occurred, and thus, it is determined that the Granger causality is significant. The “p value” indicates the probability that a value equal to or greater than the realized value is obtained in the F distribution curve calculated by the Granger causality test.

The p value in the F distribution indicates the area of the upper tail in the graphs illustrated in FIGS. 9(a) and 9(b). Therefore, if the p-value is smaller than 0.05, it is inferred that rare events have occurred, and thus it is determined that the Granger causality is significant.

Granger causality indicates that it is more accurate to adopt the information of the data xj of the item j when modeling the data xi of the item i. The fact that a highly accurate model can be created means that the future prediction accuracy of the data xi is also increased. In the present embodiment, it is possible to extract the preceding relationship with higher accuracy by calculating the degree of surprise rij for the two items i and j and further performing the Granger causality test for the two items i and j. In the present embodiment, the F distribution curve has been described as an example of the distribution curve calculated by the causality test, but for example, a chi-square distribution or the like can also be used.

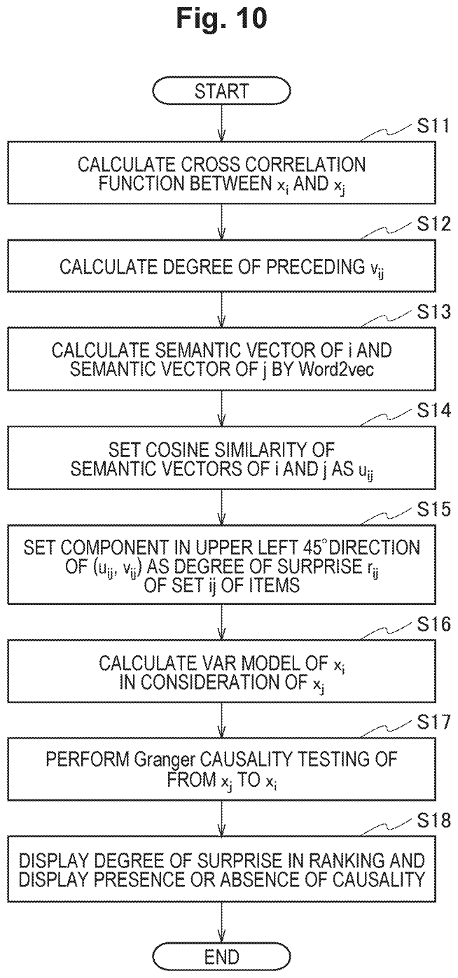

Next, a processing procedure of the above-described preceding relationship extraction device 101 will be described with reference to a flowchart illustrated in FIG. 10. First, in step S11, the preceding degree calculation unit 1 calculates a cross correlation function Rij(k) of the data xi and xj using the above-described Expression (1).

In step S12, the preceding degree calculation unit 1 calculates the degree of preceding vij of the data xj with respect to the data xi on the basis of the cross correlation function Rij(k) using the above-described Expression (3). The degree of preceding vij may be calculated using any one of the above-described Expressions (2), (4), and (5).

In step S13, the similarity calculation unit 2 calculates semantic vectors of the data xi and the data xj using “Word2vec”.

In step S14, the similarity calculation unit 2 calculates cosine similarity between the semantic vectors of the data xi and the data xj, and sets this result as semantic similarity uij.

In step S15, the surprise degree calculation unit 3 sets a component in the upper left 45° direction (135° direction) on the coordinate of (uij, vij), that is, a component in the direction of the straight line L illustrated in FIG. 4, as the degree of surprise rij of the set of items i and j.

In step S16, the causality testing unit 4 calculates a VAR model of the data xi in consideration of the data xj.

In step S17, the causality testing unit 4 performs a Granger causality test of from the data xj to the data xi.

In step S17, the presentation unit 5 ranks and displays the sets of the items i and j in descending order of the degree of surprise rij. In addition, a set of items i and j for which Granger causality is significant is displayed. For example, as illustrated in FIG. 11, the degree of surprise is numerically displayed for a set of items i and j, and whether the Granger causality is significant is displayed as “o” or “x”.

In FIG. 11, the user can recognize that the price of salt (item j) has changed in advance of the fixed-line telephone communication fee (item i), with “degree of surprise rij=3.800801”, and that Granger causality is significant.

As described above, the preceding relationship extraction device 101 according to the present embodiment includes: a preceding degree calculation unit 1 that calculates a degree of preceding of time series data xj of an item j with respect to time series data xi of an item i from a plurality of pieces of data; a similarity calculation unit 2 that calculates a semantic similarity between the time series data xi and the time series data xj; a surprise degree calculation unit 3 that calculates a degree of surprise indicating surprise of combining the item i and the item j on the basis of the degree of preceding and the semantic similarity; a causality testing unit 4 that tests causality of the item i and the item j; and a presentation unit 5 that presents the degree of surprise and presence or absence of the causality.

In the present embodiment, it is possible to easily extract an A-B set in which “the time series data of the item A unexpectedly tends to move ahead of the time series data of the item B” that is hardly conceived by a human from a plurality of pieces of data. Furthermore, it is possible to extract not only the time series data preceding but also the A-B set having the relationship of “item A is useful for the future prediction of item B” by performing the causality test.

In the present embodiment, since the cosine similarity of the semantic vector is considered, it is possible not only to extract that the item A precedes the item B from a plurality of pieces of data, but also to extract a set of items A and B whose meanings are far from each other among the plurality of pieces of data.

In the present embodiment, the preceding degree calculation unit 1 calculates the degree of preceding vij, on the basis of the cross correlation function of time series data xi and time series data xj. Therefore, the degree of preceding vij can be calculated with high accuracy.

In the present embodiment, the similarity calculation unit 2 calculates cosine similarity between the semantic vectors of the item i and the item j. Therefore, the semantic similarity uij can be calculated with high accuracy.

In the present embodiment, the presentation unit 5 presents a combination of the item i and the item j in a ranking format in descending order of the degree of surprise. In addition, the presence or absence of significance is presented on the basis of the test result of the causality. Therefore, the user can easily recognize the degree of surprise and significance of the combination of the two items i and j.

### Description of Second Embodiment

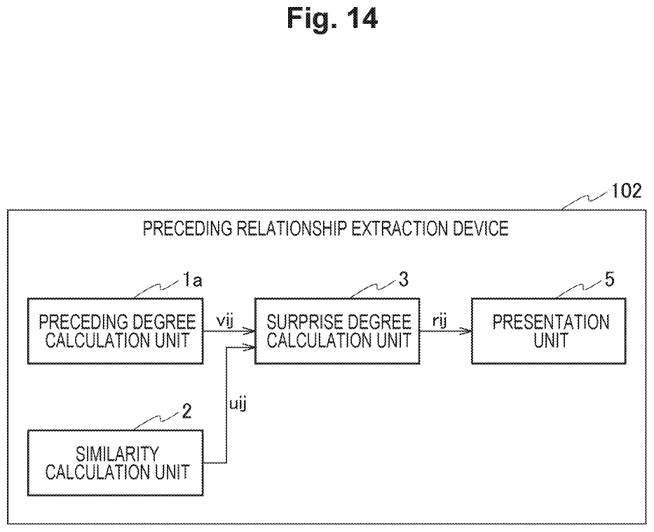

Next, a second embodiment will be described. FIG. 14 is a block diagram illustrating a configuration of a preceding relationship extraction device 102 according to the second embodiment. As illustrated in FIG. 14, the preceding relationship extraction device 102 includes a preceding degree calculation unit 1a, a similarity calculation unit 2, a surprise degree calculation unit 3, and a presentation unit 5.

The preceding degree calculation unit 1a calculates the above-described p value by performing the Granger causality test. Specifically, the p value in the graph of the F distribution illustrated in FIGS. 9(a) and 9(b) is calculated. As described above, the p value indicates the area of the upper tail in the graphs illustrated in FIGS. 9(a) and 9(b). As described above, the smaller the p value, the higher the causality of the two items i, j. The preceding degree calculation unit 1a calculates the degree of preceding vij on the basis of the p value. That is, the degree of preceding vij is calculated by “vij=f(pij)” with “f” as any function.

Specifically, the degree of preceding vij can be calculated by the following Expression (15) or Expression (16).

$$vij = ( pij - μ ) / σ \qquad ( 15 )$$

Here, μ is an average value of p values of all (i, j), and σ is a standard deviation of the p value.

$$vij = ( pij - pij\_min ) / ( pij\_max - pij\_min ) \qquad ( 16 )$$

Here, “pij_min” is the minimum value of pij, and “pij_max” is the maximum value of pij.

That is, the preceding degree calculation unit 1a calculates the degree of preceding vij on the basis of the probability (p value) that a value equal to or greater than the realized value is obtained in the F distribution curve calculated by the Granger causality test.

The configurations of the similarity calculation unit 2, the surprise degree calculation unit 3, and the presentation unit 5 are similar to those of the first embodiment described above, and thus detailed description thereof will be omitted.

In the first embodiment described above, the cross correlation function is calculated by the preceding degree calculation unit 1. On the other hand, in the preceding relationship extraction device 102 according to the second embodiment, the preceding degree calculation unit 1a calculates the degree of preceding vij using the p value of the Granger causality instead of the cross correlation function.

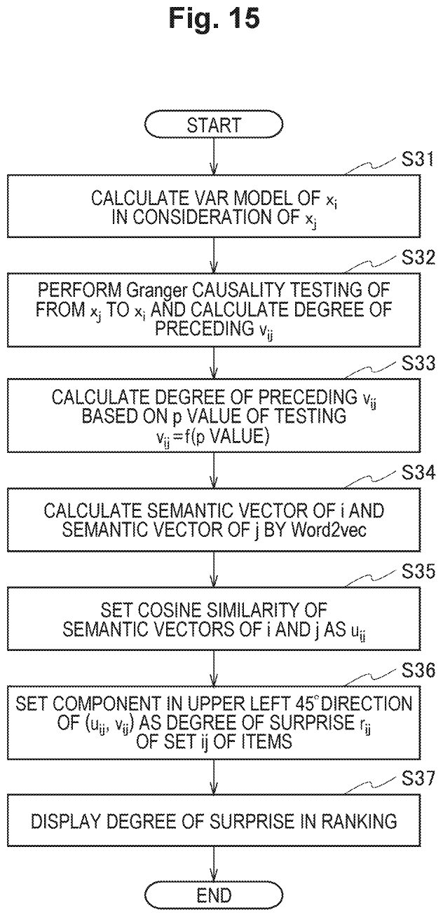

A processing procedure of the preceding relationship extraction device 102 according to the second embodiment will be described below with reference to a flowchart illustrated in FIG. 15. First, in step S31, the causality testing unit 4 obtains a VAR model of the data xi in consideration of the data xj.

In step S32, the preceding degree calculation unit 1a performs the Granger causality test of from xj to xi to calculate the p value in the F distribution. As described above, the p value in the F distribution indicates the area of the upper tail in the graphs illustrated in FIGS. 9(a) and 9(b). Therefore, it is determined that the smaller the p value, the higher the causality.

In step S33, the preceding degree calculation unit 1a calculates the degree of preceding vij on the basis of the p value. That is, the degree of preceding vij=f (p value) is calculated on the basis of Expression (15) or Expression (16) described above.

In step S34, the similarity calculation unit 2 calculates semantic vectors of the data xi and the data xj using “Word2vec”.

In step S35, the similarity calculation unit 2 calculates cosine similarity between the semantic vectors of the data xi and the data xj, and sets this result as semantic similarity uij.

In step S36, the surprise degree calculation unit 3 sets a component in the upper left 45° direction (135° direction) on the coordinate of (uij, vij), that is, a component in the direction of the straight line L illustrated in FIG. 4, as the degree of surprise rij of the set of items i and j.

In step S37, the causality testing unit 4 ranks and displays the sets of the items i and j in descending order of the degree of surprise rij in the presentation unit 5.

As a result, for example, as illustrated in FIG. 16, the degree of surprise rij is displayed in ranking.

The preceding relationship extraction device 102 according to the second embodiment includes: a preceding degree calculation unit 1a that tests causality between time series data xj of an item j and time series data xi of an item i from a plurality of pieces of data and calculates a degree of preceding of the item j with respect to the item i by a test result; a similarity calculation unit 2 that calculates a semantic similarity between the time series data xi and the time series data xj; a surprise degree calculation unit 3 that calculates a degree of surprise indicating surprise of combining the item i and the item j on the basis of the degree of preceding and the semantic similarity; and a presentation unit 5 that presents the degree of surprise.

In the preceding relationship extraction device 102 according to the second embodiment, the degree of preceding vij is calculated using the p value calculated by the causality testing unit 4. Therefore, the degree of preceding vij considering the causality of the two items i and j can be obtained, and the degree of surprise rij is calculated using the degree of preceding vij, so that it is possible to extract an unexpected preceding relationship between the two items with high accuracy.

In the second embodiment, the preceding degree calculation unit 1a performs the Granger causality test and calculates the probability (p value) that a value equal to or greater than the realized value is obtained. As the p value is smaller, there is causality that “the item j has useful information for prediction of the item i”. Therefore, by calculating the degree of preceding vij using the p value, it is possible to calculate the degree of surprise rij with high accuracy.

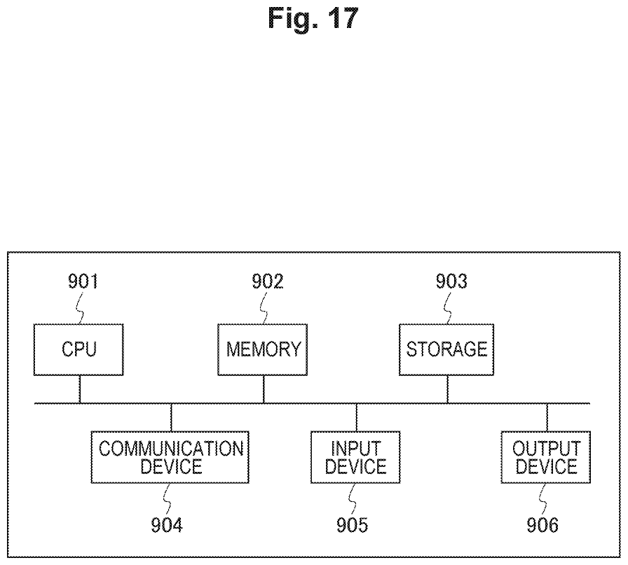

As illustrated in FIG. 17, for example, a general-purpose computer system including a central processing unit (CPU, processor) 901, a memory 902, a storage 903 (hard disk drive: HDD, solid state drive: SSD), a communication device 904, an input device 905, and an output device 906 can be used as the preceding relationship extraction device 101, 102 of the embodiments described above. The memory 902 and the storage 903 are storage devices. In the computer system, by the CPU 901 performing a predetermined program loaded on the memory 902, each function of the preceding relationship extraction device 101, 102 is implemented.

Note that the preceding relationship extraction device 101, 102 may be implemented by one computer, or may be implemented by a plurality of computers. The preceding relationship extraction device 101, 102 may be a virtual machine mounted on a computer.

The program for the preceding relationship extraction device 101, 102 can be stored in a computer-readable recording medium such as an HDD, an SSD, a universal serial bus (USB) memory, a compact disc (CD), or a digital versatile disc (DVD), or can be distributed via a network.

The present invention is not limited to the above embodiment, and various modifications can be made within the scope of the spirit of the present invention.

### REFERENCE SIGNS LIST

1, 1a Preceding degree calculation unit
2 Similarity calculation unit
2 Cross correlation function
3 Surprise degree calculation unit
4 Causality testing unit
5 Presentation unit
101, 102 Preceding relationship extraction device

1. A preceding relationship extraction device comprising:
a preceding degree calculation unit, implemented using one or more processors, configured to calculate a degree of preceding of time series data xj of an item j with respect to time series data xi of an item i from a plurality of pieces of data;
a similarity calculation unit that calculates a semantic similarity between the time series data xi and the time series data xj;
a surprise degree calculation unit, implemented using one or more processors, configured to calculate a degree of surprise indicating surprise of combining the item i and the item j based on the degree of preceding and the semantic similarity;
a causality testing unit, implemented using one or more processors, configured to test causality of the item i and the item j; and
a presentation unit, implemented using one or more processors, configured to present the degree of surprise and presence or absence of the causality.

2. The preceding relationship extraction device according to claim 1, wherein the preceding degree calculation unit is configured to calculate the degree of preceding based on a cross correlation function of the time series data xi and the time series data xj.

3. The preceding relationship extraction device according to claim 1, wherein the similarity calculation unit is configured to calculate cosine similarity between semantic vectors of the item i and the item j.

4. The preceding relationship extraction device according to claim 1, wherein the presentation unit is configured to present a combination of the item i and the item j in a ranking format in descending order of the degree of surprise.

5. A preceding relationship extraction device comprising:
a preceding degree calculation unit, implemented using one or more processors, configured to test causality between time series data xj of an item j and time series data xi of an item i from a plurality of pieces of data and calculates a degree of preceding of the item j with respect to the item i by a test result;
a similarity calculation unit, implemented using one or more processors, configured to calculate a semantic similarity between the time series data xi and the time series data xj;
a surprise degree calculation unit, implemented using one or more processors, configured to calculate a degree of surprise indicating surprise of combining the item i and the item j based on the degree of preceding and the semantic similarity; and
a presentation unit, implemented using one or more processors, configured to present the degree of surprise.

6. The preceding relationship extraction device according to claim 5, wherein the preceding degree calculation unit is configured to calculate the degree of preceding based on a probability that a value equal to or greater than a realized value is obtained in a distribution curve calculated by the Granger causality test.

7. A preceding relationship extraction method comprising steps of:
calculating, by one or more processors, a degree of preceding of time series data xj of an item j with respect to time series data xi of an item i from a plurality of pieces of data;
calculating, by one or more processors, a semantic similarity between the time series data xi and the time series data xj;
calculating, by one or more processors, a degree of surprise indicating surprise of combining the item i and the item j based on the degree of preceding and the semantic similarity;
testing, by one or more processors, causality of the item i and the item j; and
presenting, by one or more processors, the degree of surprise and presence or absence of the causality.

8. (canceled)
